(19) United States
(12) Patent Application Publication
(10) Pub. No.: US 2025/0060838 A1
(43) Pub. Date: Feb. 20, 2025

(54) DEDICATED HAND-HELD SPATIAL COMPUTING DEVICE

(71) Applicant: DOPPLE WORKS, INC., Catskill, NY (US)

(72) Inventors: Gregory FODOR, Campbell, CA (US); Robert KALIN, Catskill, NY (US); Geoffrey CHATTERTON, Southport, ME (US)

(21) Appl. No.: 18/806,486

(22) Filed: Aug. 15, 2024

Related U.S. Application Data
(60) Provisional application No. 63/532,748, filed on Aug. 15, 2023.

(51) Int. Cl. G06F 3/0346; G06F 3/01; G06F 3/02; G06F 3/0488; G06T 19/00

(52) U.S. Cl. CPC G06F 3/0346; G06F 3/013; G06F 3/02; G06F 3/0488; G06T 19/006

(57) ABSTRACT

A device for extended reality may include a sensor, a tracking sensor, a display, a processor, and a control mechanism. The sensor may generate image data representative of a physical environment of the device. The tracking sensor may determine movement of the device within the physical environment. The display may show a view of an extended reality environment. The processor may control the view of the extended reality environment based on the image data, the determined movement of the device, and a position of the device within the physical environment. The control mechanism may obtain user input that is effective to interact with the extended reality environment.

### CROSS-REFERENCE TO RELATED APPLICATIONS

This patent application claims the benefit of and priority to U.S. Provisional Application No. 63/532,748 filed Aug. 15, 2023, which is incorporated herein by specific reference in its entirety.

### FIELD

The present invention relates to a handheld device configured as a spatial computer.

### BACKGROUND

Devices (e.g., smartphones, tablets) may permit users to consume information and interact with virtual environments. Some handheld devices may include a two-dimensional display that presents information to a user and receives input from a user. These handheld devices and the two-dimensional display may be implemented as part of extended reality (XR), which may include immersive environments such as virtual reality (VR), augmented reality (AR), and/or mixed reality (MR).

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an embodiment of the present disclosure, a device may include a sensor, a tracking sensor, a display, a processor, and a control mechanism. The sensor may generate image data representative of a physical environment of the device. The tracking sensor may determine movement of the device within the physical environment. The display may show a view of an XR environment. The processor may control the view of the XR environment based on the image data, the determined movement of the device, and a position of the device within the physical environment. The control mechanism may obtain user input that is effective to interact with the XR environment.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIGS. 1A-1E illustrate various views of an example handheld device configured for XR, in accordance with one or more embodiments of the present disclosure;

FIG. 2 illustrates a block diagram of an example spatial computer, in accordance with one or more embodiments of the present disclosure; and

FIG. 3 illustrates a flow chart of an example method to generate and interact with an XR environment, in accordance with one or more embodiments of the present disclosure.

### DETAILED DESCRIPTION

Some mobile devices may decouple the user from a physical environment while using the mobile device. Such mobile devices may permit passive and/or discontinuous data consumption in which data is selected using algorithmic targeting and is consumed without user interaction. The passive and discontinuous data consumption may prevent the user from interacting with the physical environment, which may be especially detrimental to young children, as it may prevent them from learning how to observe and engage with the physical environment.

While immersive technologies, such as XR, may cause the user to interact with items beyond boundaries of the display of the mobile device, some immersive technologies include components (e.g., a headset or a head-mounted display) that occlude eyes or other body parts of the user and separate the user from the physical environment. In other words, the components of the immersive technologies may block senses of the user, which at least partially isolates the user from the physical environment.

Some spatial computers may implement a projection approach, a mobile approach, or a headset approach. The projection approach may include the spatial computer using projectors to project digital images on physical objects in the physical environment, which may limit use of the spatial computers to suitable physical environments and requires multiple projectors and sensors. The mobile approach may include the spatial computers being implemented as mobile devices (e.g., smartphones or tablets) to create an augmented reality and may be limited to the boundary of the displays of the mobile devices and lack separate controllers. The headset approach may include the spatial computers being implemented as head-mount headsets, which show the XR environment to the user. The headset approach isolates the user from the physical environment, occludes eyes of the user, and is often cumbersome and expensive.

The subject matter claimed herein is not limited to embodiments that solve any disadvantages or that operate only in environments such as those described. Rather, this background is only provided to illustrate one example technology area where some embodiments described herein may be practiced.

The present disclosure relates to a handheld device that includes a display to show the XR environment to the user. In addition, the handheld device includes a user interface that is simple and user friendly to allow the user to interact with the XR environment in an intuitive and user friendly manner. Further, the handheld device may permit the user to interact and engage with both a virtual environment (e.g., the XR environment) and the physical environment without the user being isolated from the physical environment. The user interacting and engaging with both the XR environment and the physical environment may assist the user to learn how to observe and engage with the physical environment.

The handheld device may be used for educational purposes, entertainment purposes, or both. For example, the XR environment may include a book (e.g., a virtual object) that assists the user to learn reading skills or to simply read the book. As another example, the XR environment may include boxes (e.g., virtual objects) that can be opened by the user to complete challenges and/or receive accomplishments. As yet another example, the XR environment may include a virtual character (e.g., a virtual object) that guides the user through the XR environment or presents information in a manner that assists the user to learn about a topic.

In some embodiments, the present disclosure relates to a spatial computer that does not isolate the user from the physical environment. The spatial computer may include a display for a user to engage with while also allowing the user to interact with the physical environment without blocking the senses of the user. The spatial computer may operate in three-dimensional space using immersive technologies such as AR, VR, MR, among others. In the present disclosure, immersive technologies including AR, VR, and MR may be collectively referred to as XR. In some embodiments, a reference to the XR environment may include a general reference to the different types of immersive technology environments. In other embodiments, a reference to the XR environment may refer to a specific type of immersive technology environment.

In some embodiments, the spatial computer may allow a user to interact with virtual objects as if the virtual objects were in the physical environment of the user. In these and other embodiments, the spatial computer may allow the user to experience a more intuitive, engaging, and immersive learning experience.

The embodiments of the present disclosure may improve accessibility to a spatial computer. For example, the spatial computer may be implemented on a dedicated handheld device (generally referred to herein as “handheld device” or “device”). For example, the handheld device may allow the user to easily access the XR environment without being isolated from the physical environment. The user may conveniently interact with the XR environment by moving or otherwise engaging with the handheld device in the physical environment. The user may also conveniently interact with the XR environment through control mechanisms (e.g., buttons or other user interfaces) of the handheld device.

The embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

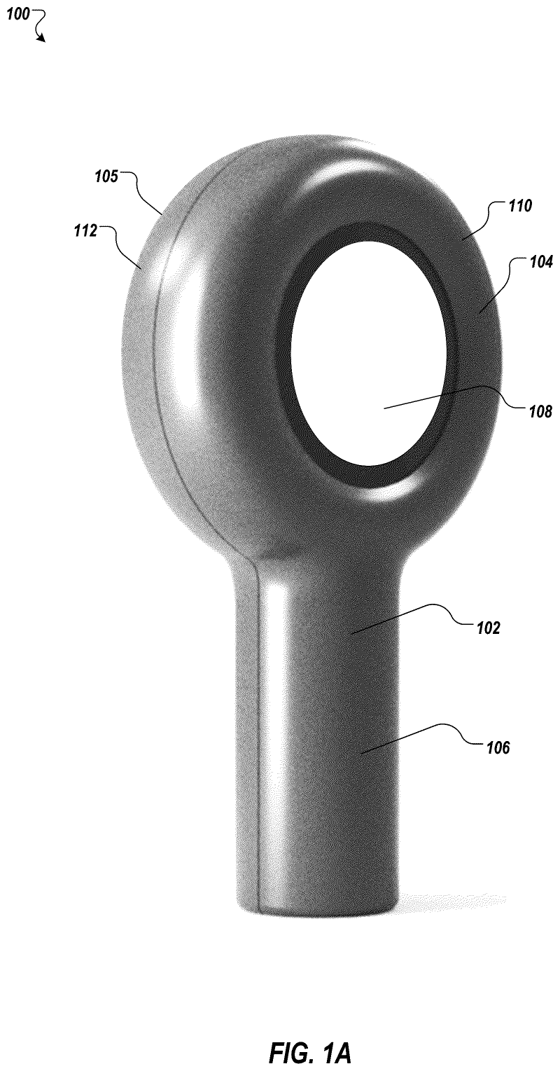

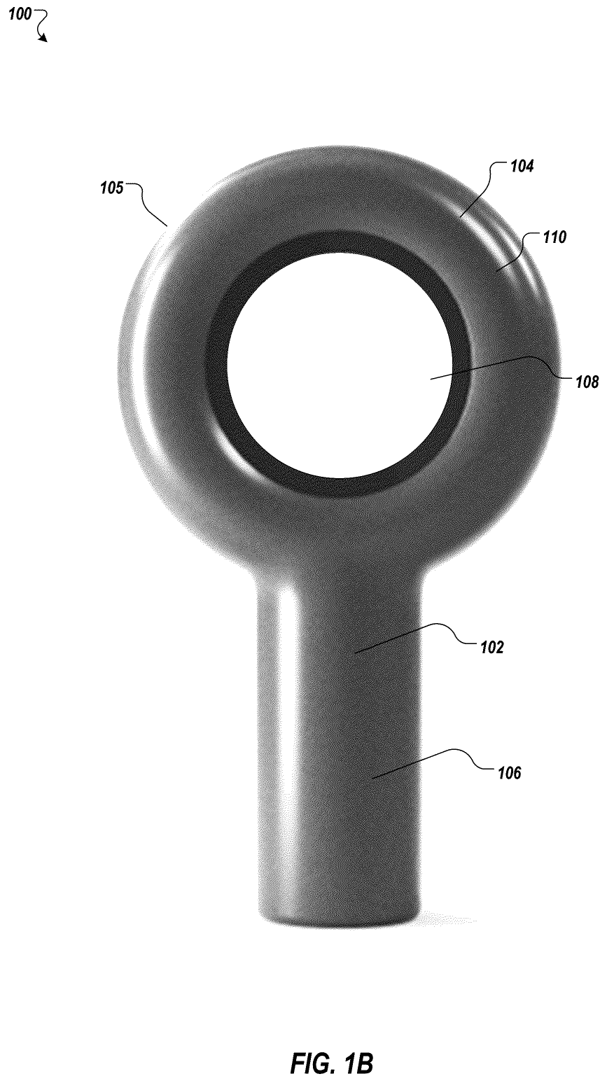

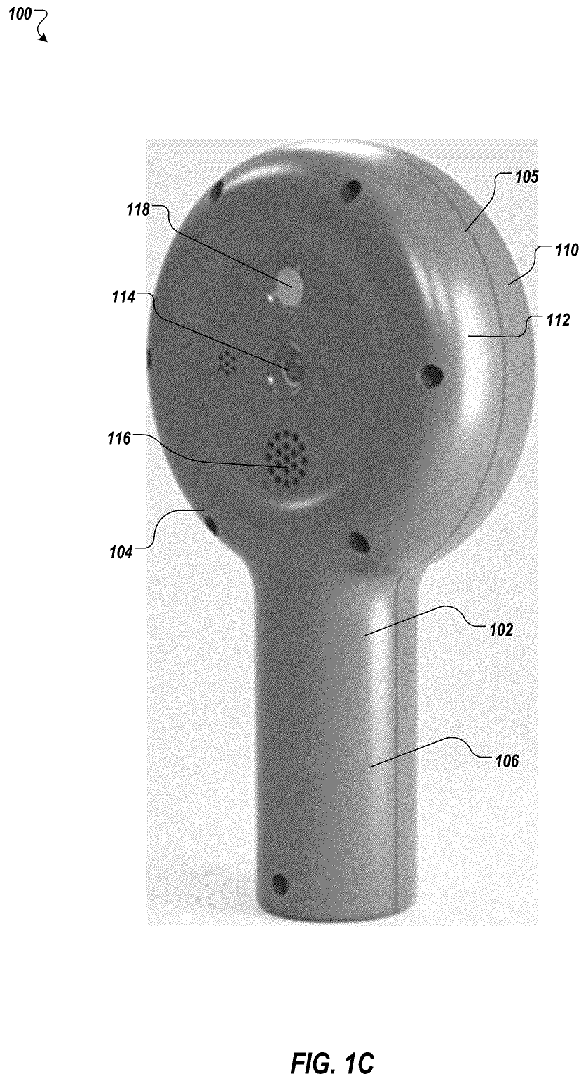

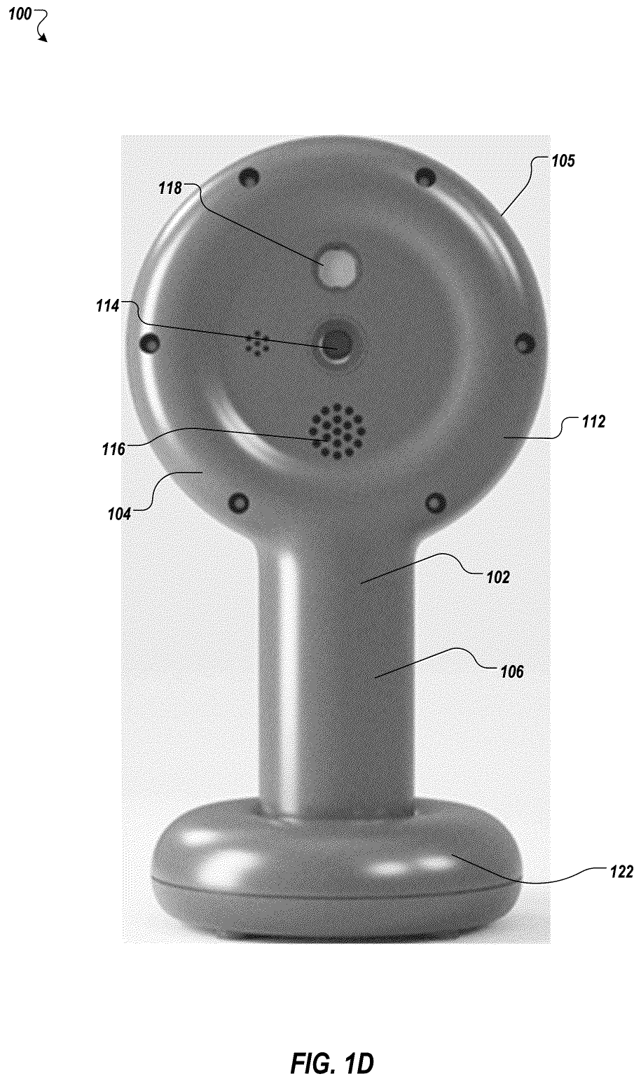

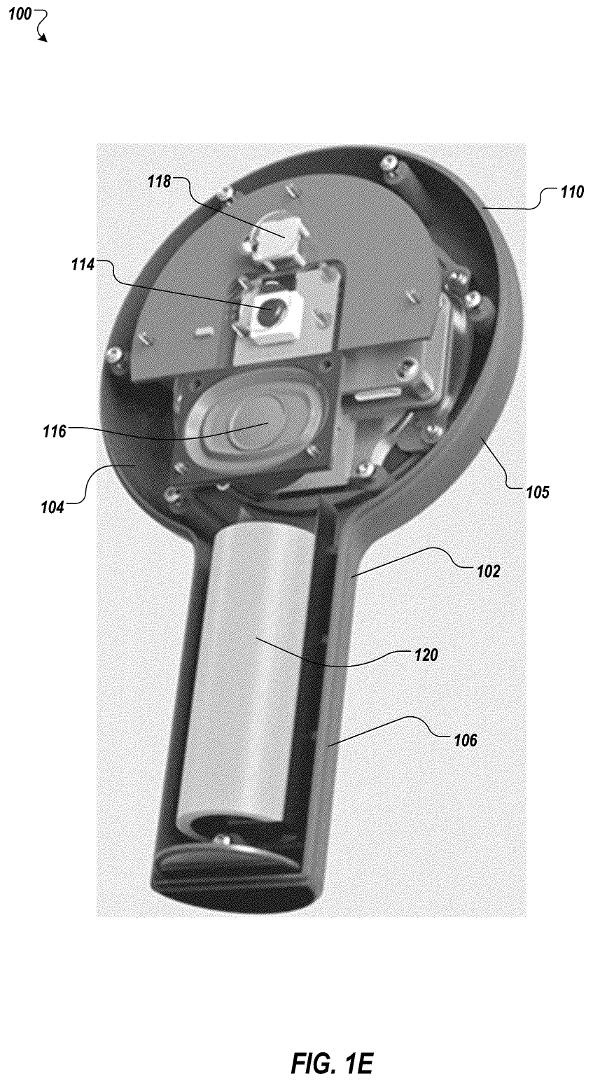

FIGS. 1A-1E illustrate different views of an example handheld device 100 (generally referred to in the present disclosure as the device 100) configured for spatial computing, in accordance with one or more embodiments of the present disclosure. In some embodiments, the device 100 may be configured and/or designed to implement an XR system. For example, the device 100 may be configured to provide an XR experience (e.g., show an XR environment) to a user of the device 100.

As depicted in the example shown in FIGS. 1A-1E, the device 100 is shaped similar to a magnifying glass (e.g., with a handle and a display in place of the glass). While depicted as being structurally similar to a magnifying glass, the device 100 may be built in any other suitable shape and/or form. The device 100 may be sized and/or shaped to fit and/or be held in a hand of the user. For example, the handle of the device 100 may be sized and/or shaped to fit and/or be held in the hand of the user. As another example, the handle of the device 100 may be omitted and a housing and a display 108 of the device 100 may be sized and/or shaped to fit and/or be held in the hand of the user.

The device 100 may include a body 102 configured to house and/or contain one or more components of the device 100 including the display 108. The body 102 may include an upper body 104 and a lower body 106.

In some embodiments, the upper body 104 may include a substantially circular shape. For example, the upper body 104 may include an outer surface 105 that is substantially circular. The upper body 104 may include a first side 110 and a second side 112 that are configured to couple to each other. The outer surface 105, the first side 110, and the second side 112 may form the upper body 104. While described as being separate parts and/or portions, in some embodiments, the outer surface 105, the first side 110, and the second side 112 may be manufactured and/or built as a single part. Although illustrated as including a circular shape in FIGS. 1A-1E, the upper body 104 may be include any suitable shape. For example, the upper body 104 may include a triangular shape, a diamond shape, a rectangular shape, a square shape, or any other appropriate shape.

The first side 110 may define an opening configured to receive the display 108. For instance, the opening may be configured to at least partially house the display 108 to make a viewing portion of the display 108 available to the user. The opening may have any suitable shape and/or size to receive the display 108. For example, the opening may have a circular shape configured to receive the display 108. In some embodiments, the opening may be shaped based on the shape of the upper body 104. For example, based on the upper body 104 including a circular shape, the opening may also be a circular shape.

The upper body 104 may protect the display 108 from being damaged during transport or use. For example, sides of the display 108 may be covered by the upper body 104 to prevent the sides of the display 108 or other portions of the display 108 from being damaged. Additionally or alternatively, the upper body 104 may be configured to be thicker than the display 108 to cause the upper body 104 to contact a ground or other surface more than the display 108 when the device 100 is dropped.

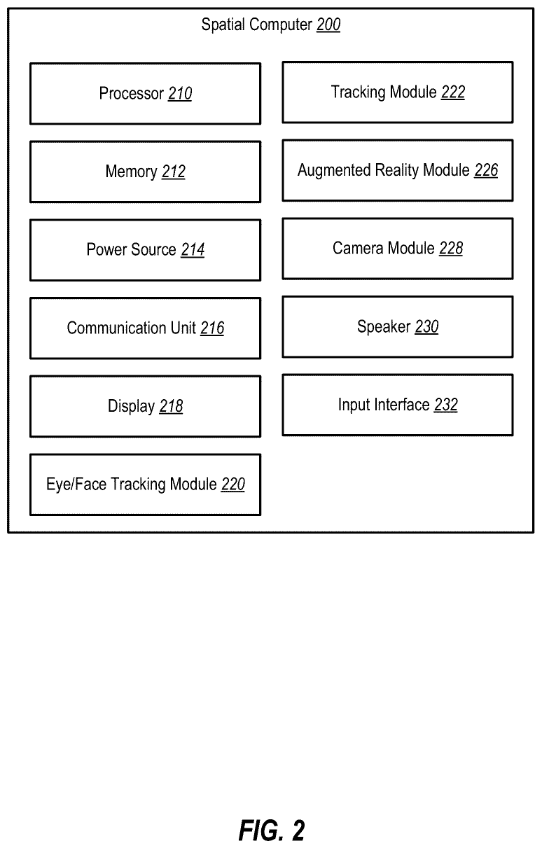

In some embodiments, a processor (such as denoted processor 210 in FIG. 2) of the device 100 may generate the XR environment based on features of a physical environment of the device 100. For example, the device 100 may include a camera 114 (e.g., a sensor) configured to generate image data representative of the physical environment, and the XR environment may be generated based on the image data. In some embodiments, the XR environment may include a virtual environment generated irrespective to the physical environment. For example, the virtual environment may depict an environment that does not correspond to the physical environment captured by the camera 114.

In some embodiments, the display 108 may show a view (e.g., a portion) of the XR environment. For example, the device 100 may be configured to act similar to a viewer, such as a magnifying glass, in which the view of the XR environment displayed on the display 108 may change based on movement of the device 100, movement of the user, interactions of the user, or some combination thereof. For example, the view of the XR environment shown on the display 108 may change based on a location and/or a direction of the device 100. As another example, the view of the XR environment shown on the display 108 may be modified based on interactions of the user (e.g., user input) with the XR environment.

The device 100 may be used in an orientation in which the display 108 faces the user. For example, the user may hold the device 100 such that the display 108 faces the user.

The XR environment may include virtual objects. In these and other embodiments, such virtual objects may be shown in the display 108 as if the virtual objects were in the physical environment. In some embodiments, the virtual objects may include boxes, books, virtual characters, or any other appropriate object.

The view of the XR environment shown on the display 108 may illustrate the physical environment in a substantially real manner. For example, the XR environment may depict the physical environment such that it appears as if the display 108 is directly viewing the physical environment. Appearance and/or placement of the virtual objects in the XR environment may cause the user to think that the virtual objects are placed in the physical environment.

In some embodiments, the view of the XR environment shown on the display may remain in a particular orientation and/or perspective regardless of the movement of the device 100. For example, as the device 100 is moved (e.g., is rotated, tilted, turned, etc.), the device 100 may automatically rotate and/or level the view of the XR environment shown on the display 108, such that the XR environment remains in a certain orientation regardless of the movement of the device 100. For example, the display 108 may show the XR environment in a natural orientation with respect to the ground (e.g., perpendicular to the ground).

The second side 112 of the upper body 104 may include multiple openings configured to receive different components. For example, the second side 112 may include a second opening configured to receive at least part of the camera 114. For example, a portion of the camera 114 may be housed in the body 102 and a lens of the camera 114 may be uncovered. In some embodiments, the camera 114 and the second opening may be located in any suitable location to obtain the image data. For example, while FIGS. 1C-1D illustrate the camera 114 as being located at a center position of the second side 112, the camera 114 may be located in any suitable location.

The second side 112 may include a third opening configured to receive at least part of a speaker 116. In some embodiments, the third opening may allow sound generated by the speaker 116 to reach the user. Additionally or alternatively, the second side 112 may include a fourth opening configured to receive a tracking sensor 118. In some embodiments, the tracking sensor 118 may be used to determine the location, the orientation, and/or the movement of the device 100. In some embodiments, the second side 112 may include any other openings for operation of the device 100. For example, the second side 112 may include openings for heat dissipation, a microphone, or any other appropriate function or device.

The processor may generate, based on the image data, the XR environment as a virtual representation of the physical environment. In addition, the processor may control the view of the XR environment based on environmental data, the image data, user input, or both. For example, the processor may control the view of the XR environment based on the image data, the determined movement of the device 100, the position of the device 100, the user input, or some combination thereof. As another example, the processor may adjust the view of the XR environment on the display 108 based on the determined movement of the device 100 or a change in location of the device 100.

In some embodiments, the lower body 106 may be used as the handle for the device 100. For example, the user may hold the lower body 106 in their hand. In some embodiments, the lower body 106 may be shaped in any suitable shape for the user to hold in their hand. For example, the lower body 106 may include a cylindrical shape.

In some embodiments, the lower body 106 may include control mechanisms (e.g., buttons or controllers) configured to receive user input. For example, the control mechanisms may include a trigger, an analog stick, a touchpad, a button, a squeeze grip, a D-pad, or some combination thereof. The control mechanisms may be configured to obtain the user input in a manner that is effective to interact with the XR environment. For example, the control mechanisms may include a button that when engaged is effective to grab the virtual objects in the XR environment.

The control mechanisms may be located in any suitable location of the lower body 106. For example, in embodiments in which the device 100 includes the trigger, the trigger may be located on a back side (e.g., a side opposite of the display 108) to afford the user a sense of picking up objects that are shown on the display 108 using natural hand movements (e.g., picking up the object using multiple fingers).

The device 100 may include a power source 120. In some embodiments, the power source 120 may be housed in the lower body 106. The power source 120 may include a removable, a replaceable, and/or a rechargeable battery. In embodiments in which the power source 120 includes the rechargeable battery, the power source 120 may be recharged using a power cable and or a charging dock 122 shown in FIG. 1D. For example, the device 100 may include a charging port (not shown) configured to receive the power cable and/or connect with the charging dock 122.

Modifications, additions, or omissions may be made to FIGS. 1A-1E without departing from the scope of the present disclosure. For example, the device 100 may include more or fewer elements than those illustrated and described in the present disclosure.

FIG. 2 illustrates a block diagram of an example spatial computer 200, in accordance with one or more embodiments of the present disclosure. In some embodiments, the spatial computer 200 may be implemented on the device 100 of FIGS. 1A-1E. The spatial computer 200 may be configured to generate information to generate, interact, or control the display of the XR environment. The spatial computer 200 may include a processor 210, a memory 212, a power source 214, a communication unit 216, a display 218, a camera module 228, an eye/face tracking module 220, a tracking module 222, an augmented reality module 226, a speaker 230, or an input interface 232.

Generally, the processor 210 may include any suitable special-purpose or general-purpose computer, computing entity, or processing device including various computer hardware or software modules and may be configured to execute instructions stored on any applicable computer-readable storage media. For example, the processor 210 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

In some embodiments, the processor 210 may be configured to facilitate operations of different parts of the spatial computer 200. For example, the processor 210 may be configured to obtain and process inputs from different parts of the spatial computer 200 such as different modules.

Although illustrated as a single processor in FIG. 2, it is understood that the processor 210 may include any number of processors distributed across any number of networks or physical locations that are configured to perform individually or collectively any number of operations described herein. In some embodiments, the processor 210 may interpret and/or execute program instructions and/or process data stored in the memory 212. In some embodiments, the processor 210 may execute the program instructions stored in the memory 212. For example, the processor 210 may execute program instructions stored in the memory 212 that are related to task execution such that the spatial computer 200 may perform or direct the performance of the operations.

The memory 212 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 210.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 210 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The power source 214 may include energy storage devices for powering components of the spatial computer 200. For example, the power source 214 may include one or more batteries. The power source 214 may correspond to the power source 120 of FIGS. 1A-1E.

The communication unit 216 may include any component, device, system, or combination thereof that is configured to transmit or receive information over a network. In some embodiments, the communication unit 216 may communicate with other devices at other locations, the same location, or even other components within the same system. For example, the communication unit 216 may include a modem, a network card (wireless or wired), an infrared communication device, a wireless communication device (such as an antenna), and/or chipset (such as a Bluetooth® device, an 802.6 device (e.g., Metropolitan Area Network (MAN)), a WiFi device, a WiMax device, cellular communication facilities, etc.), and/or the like. The communication unit 216 may permit data to be exchanged with a network and/or any other devices or systems described in the present disclosure.

The display 218 may be configured as one or more displays, like an LCD, LED, Braille terminal, or other type of display. The display 218 may correspond to the display 108 of FIGS. 1A-1E. The display 218 may show the XR environment, and/or present instructions, captions, user interfaces, and other data as directed by the processor 210. In some embodiments, the display 218 may include a touch sensitive display. For example, the display 218 may include a display and/or a screen that is resistive (e.g., pressure sensitive), capacitive (e.g., touch sensitive), projected capacitive, or that uses acoustic waves and infrared signals to identify touches by the user.

In some embodiments, the display 218 may be substantially circular in appearance to the user. For example, the display 218 or a portion of the display 218 visible to the user may be circular. In some embodiments, the display 218 itself may be constructed as a substantially circular display. In these and other embodiments, the display 218 may be housed inside a housing and/or a body in which at least a portion of the display 218 is viewable and/or interactable with by the user.

In some embodiments, the display 218 may be constructed in a non-circular design. For example, the display 218 may be built and/or produced as a rectangle, a square, or any other non-circular shape. In these and other embodiments, the display 218 may be cropped to appear circular to the user. For example, the display 218 may be placed in a housing with a circular opening. For instance, only a circular portion of the display 218 may be uncovered by the housing while the rest of the display 218 is placed within the housing, making it inaccessible (e.g., unviewable and/or untouchable) by the user. In these instances, only the circular portion of the display 218 may be utilized to present content. For instance, a portion of the display 218 covered by the housing may not be utilized. In some embodiments, with the display 218 including a non-circular shape, the display 218 may be projected as being circular. For example, while the entire or large portions of the display 218 may be viewable and/or touchable (except for portions used for mounting the display 218 to a housing), only a circular portion of the display 218 may be utilized to display information and/or content.

In some embodiments, the circular display may allow the users to rotate the display 218 and there may be no visual preference of orientation that the spatial computer 200 is intended based on the shape of the display 218. For example, the spatial computer 200 may be positioned in any orientation and content shown on the display 218 may remain in a certain orientation (e.g., in line with ground). For instance, the spatial computer 200 may automatically rotate and/or level the content shown on the display 218 such that the content remains in a certain view and/or level regardless of the orientation of the spatial computer 200. For instance, the processor 210 may automatically adjust the content shown on the display 218 to remain in a certain view and/or level. In these instances, the user may hold and/or orient the spatial computer 200 in any way and still get the content shown in the same manner and/or direction. In some embodiments, the display 218 may be configured to rotate to match the orientation of the spatial computer 200. For example, the display 218 may be configured to show the content in the same manner and/or direction relative to the spatial computer 200.

In some embodiments, environmental data (e.g., translational movements and rotational movements) corresponding to the spatial computer 200 or other items in the physical environment may be used as input data with respect to the virtual objects and/or the XR environment. For example, the environmental data may represent movement of a hand of the user holding or using the spatial computer 200. As another example, the user may indicate that a virtual object is being grabbed and/or interacted with by activating a key or a button (e.g., a control mechanism) with a natural grasping motion. For instance, the user may indicate that the user is “picking up” a virtual object shown on the display 218 by selecting a representative region shown in the display 218. After the user begins interacting with the virtual object, the movements of the spatial computer 200 may be used as input data to move the virtual object within the XR environment.

In some embodiments, the XR environment in which the virtual object is depicted may not move and/or rotate as the virtual object is being moved. For example, the XR environment may be automatically rotated and/or leveled such that the XR environment does not move (or appear on the display 218 as not moving) regardless of the movement of the spatial computer 200. For example, the movement of the spatial computer 200 may only move the virtual object without moving the XR environment, such that the virtual object may be intuitively and spatially manipulated within the XR environment. The separation of the virtual object from the XR environment based on the movement of the user's hand (or the spatial computer 200) may provide the user with a sense of closer engagement with the virtual object. For example, the user may feel as if the user is physically picking up the virtual object.

In some embodiments, the environmental data may be used to alter and/or modify the view of the XR environment shown on the display 218 instead of a discrete virtual object within the XR environment. For instance, the environmental data may be used to manipulate a first-person point of view (POV) of the user. For example, translational and/or rotational movements of the spatial computer 200 may represent changing of the user's viewpoint. For example, by turning the spatial computer 200, the content shown on the display 218 may rotate out of the view shown on the display 218, which may allow the user to look left, right, and/or up and down within the XR environment.

A scaling factor may be used to further alter the POV of the user within the XR environment. For example, the XR environment may be manipulated in a way that appears as if the user is pulling closer or pushing away from the XR environment. For instance, the user may act as if grabbing the XR environment (e.g., through the grasping motion via the display 218 and/or use of a user interface such as a button) and pull in or push away the XR environment based on the movement of the spatial computer 200. In some embodiments, movement of the spatial computer 200 and/or the user may be amplified, such that the distance traveled in the XR environment is greater than the actual distance that the spatial computer 200 moved. In these and other embodiments, such amplification may permit the XR environment to cover a larger area than the physical space that the spatial computer 200 operates in.

The engagement with a virtual object in the view of the XR environment and/or an on-screen user interface shown on the display 218 and rotational and/or translational movements (e.g., engaging with or moving the XR environment) may both be initiated using a same user interface of the spatial computer 200, such as the control mechanism. In these and other embodiments, the engagement may be differentiated based on rotation of the spatial computer 200. For example, the angle of the spatial computer 200 with respect to the vertical axis may be used to differentiate between the engagements. For instance, initiating action through the control mechanism while the spatial computer 200 is within a first range of degrees may initiate engagement. Interacting with the control mechanism while the spatial computer 200 is in a second range of degrees may indicate translational movements. In some embodiments, the first range of degrees may correspond to the natural movement range of a user, such as between 0 degree and 90 degrees. In these and other embodiments, the second range of degrees may correspond to beyond 90 degrees. In some embodiments, the first range of degrees and the second range of degrees may be customized and/or determined by the user.

In some embodiments, the spatial computer 200 may be configured such that the spatial computer 200 may be used in different handedness orientations. For example, the spatial computer 200 may be used by either right-handed or left-handed people. For example, the on-screen controls may be moved within the display based on the handedness of the user to accommodate a hand preference of the user. In some embodiments, the current hand preference may be determined based on orientation of the spatial computer 200 and the range of rotational movements. For example, the current hand preference may be determined based on natural resting positions and/or useful range of motions associated with different handedness of the user. For example, natural resting position of the spatial computer 200 in a right hand may be approximately 45 degrees from vertical, with a useful range of motion from 0 to about 135 degrees. The range may be mirrored in the left hand, which may rest at approximately −45 degrees from vertically upright. As one example, a slider control could be implemented as an indicator on a circumferential arc from 0 to 135 degrees that is manipulated by twisting the wrist in plane with the display 218. In instances in which the current rotation angle stretches much beyond vertical to the other side, the spatial computer 200 may be assumed to have switched hands and the slider then may be mirrored on the display 218 to match a new working range of 0 to −135 degrees. To lessen the chance of a false hand change detection, the control can stop before the 0 degree upright position, for example at about 10 or 15 degrees, and add hysteresis. This allows a buffer where the slider control will visually reach an end stop that is before the upright orientation that would trigger the control to mirror.

In some embodiments, the display 218 may allow the user to adjust the orientation of the display 218 relative to the spatial computer 200. For example, the orientation of the display 218 may be adjusted using physical mechanisms. For instance, the user may use a hinge to angle the display 218 to get better vantage point of virtual objects for manipulation with motion of the spatial computer 200 and/or the input interface 232.

The camera module 228 may include cameras configured to capture image data representative of the physical environment and/or objects around the users. The camera module 228 may correspond to the camera 114 of FIGS. 1A-1E. Additionally or alternatively, the camera module 228 may include video cameras, visual sensors, and/or any other device suitable of capturing the image data as a video representative of the physical environment. In some embodiments, the camera module 228 may be configured to provide a camera feed to the display 218. For example, the camera feed may be shown on the display 218 with minimal delay.

The camera module 228 may include light sources configured to assist capturing the image data representative of the physical environment. For example, the light sources may be operated in response to the camera module 228 not detecting enough light to properly capture the image data.

In some embodiments, the camera module 228 may be located on an opposite side of the spatial computer 200 from the display 218. For instance, the camera module 228 may be located to allow the user to capture the image data representative of the physical environment and/or objects around the user while viewing the display 218.

The eye/face tracking module 220 may track eye position and/or a face orientation of a user of the spatial computer 200. In some embodiments, the eye/face tracking module 220 may obtain a measurement of distance between the spatial computer 200 (e.g., the display 218) and the user's face and/or eyes. For example, the eye/face tracking module 220 may obtain the measurement using sensors such as ultrasonic distance sensors, short range radar, computer vision cameras, LiDAR, among others. For instance, the eye/face tracking module 220 may be located near the display 218 and as the user is looking at or interacting with the display 218, the eye/face tracking module 220 may determine the distance between the user and the spatial computer 200 (e.g., the display 218).

In some embodiments, the eye/face tracking module 220 may be further configured to calculate an effective viewing angle of the display 218 for the user. For example, the eye/face tracking module 220 may use the measured distance and/or various information about the spatial computer 200 (e.g., a native camera field of view (FoV), size of the display 218, etc.) to calculate the effective viewing angle of the display 218 for the user. In these and other embodiments, the effective viewing angle of the display 218 for the user may be used to scale and/or crop the camera feed to maintain a view with a subtended angle consistent with physical distance between the user and the display 218. For instance, the virtual objects in the XR environment may be scaled along with a camera view to help preserve an illusion of physical reality of the XR environment, the virtual objects, or both.

In some embodiments, the virtual objects may include a virtual character that includes a face, one or more eyes, or other facial features. In these and other embodiments, the effective viewing angle of the display 218 for the user may be used to control an orientation of the virtual character and/or aspects of the virtual character to maintain apparent eye contact of the virtual character with the user. For example, a direction of the face of the virtual character, a direction of a gaze of the one or more eyes of the virtual character, or both may be adjusted based on the effective viewing angle of the display 218 to maintain the apparent eye contact of the virtual character with the user. Additionally or alternatively, the eye/face tracking module 220 may track the eye position and/or the face orientation of the user of the spatial computer 200 to adjust the direction of the face of the virtual character, the direction of the gaze of the one or more eyes of the virtual character, or both to maintain the apparent eye contact of the virtual character with the user

The tracking module 222 may include devices and/or sensors for inside-out tracking of the spatial computer 200. For example, the devices and/or sensors may be configured to track the orientation, the location, and/or the movement of the spatial computer 200. For example, the tracking module 222 may include an inertial measurement unit (IMU) configured to measure and/or report acceleration, orientation, angular rates, and other gravitational forces of the spatial computer 200. In some embodiments, the IMU may include different types of sensors. For example and without limitation, the IMU may include an accelerometer(s), a magnetometer(s), a gyroscope(s), a magnetic compass(es), and/or other sensor types. In some embodiments, the IMU may be implemented using any suitable number (e.g., 1, 2, 3, 4, 5, 6, 7, 8, 9, 10, 11, 12, etc.) of degrees of freedom. In these and other embodiments, the different types of sensors included in the IMU may vary depending on the number of degrees of freedom. For example, in six degrees of freedom (6DoF) and/or six-axis applications, the IMU may include accelerometers and gyroscopes, while in nine-axis applications, the IMU may include accelerometers, gyroscopes, and magnetometers.

Additionally or alternatively, the tracking module 222 may include tracking cameras. In these and other embodiments, the tracking cameras may be used with computer vision techniques to track orientation, location, and/or movements of the spatial computer 200. In some embodiments, the tracking module 222 may include any other devices and/or methods, such as a global positioning system, to track location, movement, and/or orientation of the spatial computer 200.

The augmented reality module 226 may provide content for the display 218 to show. For example, the augmented reality module 226 may generate the XR environment as an augmented reality environment representative and/or depicting the physical environment based at least on the image data obtained using the camera module 228. In some embodiments, the XR environment may be a realistic depiction of the physical environment. For example, the XR environment may be generated to be the same or similar to the camera feed of the camera module 228. In some embodiments, the augmented reality module 226 may modify the physical environment and/or objects for display in the XR environment. For example, the augmented reality module 226 may apply different effects to the physical environment and/or objects for display in the XR environment.

Additionally or alternatively, the augmented reality module 226 may generate content and/or the virtual objects to be placed in the XR environment. For example, the augmented reality module 226 may include an augmented reality engine which may generate the content and/or the virtual objects. As another example, the augmented reality module 226 may generate boxes to be placed in the XR environment.

In some embodiments, the augmented reality module 226 may generate the content and/or the virtual objects based on different parameters. For example, the augmented reality module 226 may obtain the environmental data, the user input, or any combination thereof and may generate the content and/or the virtual objects based on the obtained information, which may be provided to the user through the display 218.

The augmented reality module 226 may obtain the content and/or the virtual objects from an outside source. For example, the augmented reality engine may not be located within the spatial computer 200 and may obtain the content and/or the virtual objects from a remote server and/or a remote device.

The spatial computer 200 may include a virtual reality module (not shown) configured to generate the XR environment as a virtual reality environment to be shown on the display 218. For example, instead of displaying the XR environment as the augmented reality environment generated by the augmented reality module 226, the display 218 may show the XR environment as the virtual reality environment. In some embodiments, the XR environment may be generated based at least on a type of game and/or content being played and/or shown via the display 218. For instance, the XR environment may be generated as different virtual reality environments for different games and/or content. Additionally or alternatively, the virtual objects may be generated and/or placed in the XR environment based at least on the type of game and/or content being played and/or shown via the display 218. In these and other embodiments, the virtual objects may be interacted with (e.g., moved, modified, etc.) using the spatial computer 200 as described elsewhere in the present disclosure.

The speaker 230 may be configured to output audible sounds related to the view of the XR environment shown on the display 218. The speaker 230 may correspond to the speaker 116 of FIGS. 1A-1E. The audible sounds may include audible instructions, communications with other devices, etc. For example, the audible sounds may include instructions, comments, or any type of speech of the virtual character. The speaker 230 may include any speaker suitable for the spatial computer 200.

The input interface 232 may include control mechanisms to allow the user to send commands and/or requests to the spatial computer 200. The commands and/or the requests may relate to certain actions. For example, the particular command may cause a particular application to be launched. As another example, the particular command may relate to actions within the particular application or within the XR environment. For instance, the particular application may cause actions to be taken in relation to different virtual objects (e.g., boxes) shown on the display 218. In these instances, the actions may include picking up the virtual objects, carrying the virtual objects, reorienting the virtual objects, or releasing the virtual objects, among others. In some embodiments, the control mechanisms may include any suitable input mechanisms. For example, the control mechanisms may include triggers, analog sticks, touchpads, buttons, squeeze grips, d-pads, etc. In some embodiments, the input interface 232 may include any other suitable type of input devices. For example, the input interface 232 may include a microphone configured to receive voice input.

Additionally or alternatively, the input interface 232 may include response mechanisms configured to provide a response after receiving user input. For example, the response may indicate to the user that the user input has been received by the spatial computer 200. For instance, the input interface 232 may include haptic feedback motors configured to provide haptic feedback. For example, in response to the user clicking a button to pick up the virtual object, the spatial computer 200 and/or the button may vibrate. In some embodiments, the response may include an audible sound being output through the speaker 230 and/or a signal indicated on the display 218.

In some embodiments, the control mechanisms may be built into the spatial computer 200 (e.g., the body 102 of the device 100 of FIGS. 1A-1E). In some embodiments, the control mechanisms may be external to the spatial computer 200 (e.g., the device 100 of FIGS. 1A-1E). For example, the external control mechanisms may include a controller, a mouse, or a keyboard connected to and/or attached to the spatial computer 200. In some embodiments, the external control mechanisms may be connected to the spatial computer 200 via a wired connection. For example, the spatial computer 200 may include an interface to receive the external control mechanisms. In some embodiments, the external control mechanisms may be connected to the system wirelessly using any suitable wireless mechanisms (e.g., Bluetooth®, WiFi, radio-frequency (RF), etc.).

In some embodiments, the input interface 232 may include an on-screen interface shown via the display 218. For example, in instances in which the display 218 is touch sensitive, an on-screen interface may be displayed. In these and other embodiments, the user may interact with the spatial computer 200 via the on-screen interface.

In some embodiments, the commands and/or the requests may be generated using the orientation of the spatial computer 200. For example, the spatial computer 200 may be rotated to alter what is shown on the display 218 and/or to interact with XR environment. For example, by rotating the spatial computer 200, the view of the XR environment shown on the display 218 may be zoomed in, zoomed out, and/or a field of view may be adjusted.

In the present disclosure, modules such as the eye/face tracking module 220, the tracking module 222, the augmented reality module 226, or the camera module 228 may be implemented using hardware including processors, central processing units (CPUs) graphics processing units (GPUs), data processing units (DPUs), parallel processing units (PPUs), microprocessors (e.g., to perform or control performance of operations), field-programmable gate arrays (FPGA), application-specific integrated circuits (ASICs), accelerators (e.g., deep learning accelerators (DLAs), optical flow accelerators (OFAs)), programmable vision accelerators (including direct memory address (DMA) systems and/or vector processing units (VPUs)), and/or other processor types. In some other instances, the modules may be implemented using a combination of hardware and software. In the present disclosure, operations described as being performed by a respective module may include operations that the respective module may direct a corresponding computing system to perform.

Modifications, additions, or omissions may be made to FIG. 2 without departing from the scope of the present disclosure. For example, the spatial computer 200 may include more or fewer elements than those illustrated and described in the present disclosure.

For example, in some embodiments, the spatial computer 200 may include a hand-tracking module (not shown). In these and other embodiments, the hand-tracking module may include sensors configured to track movements of hand(s) of the user. For example, the hand-tracking module may include cameras configured to track movements of the hand(s) of the user. The hand-tracking module may process the movements (e.g., direction, speed, orientation, etc.) of the hand(s) to cause the spatial computer 200 to modify and/or interact with the XR environment. For example, the movements of the hand(s) may be integrated in the spatial computer 200 to interact with the XR environment. For instance, depictions of the hand(s) of the user may be shown in the XR environment, which may appear to nudge and/or push the virtual object. In these instances, the virtual object may be moved in the XR environment by the depictions of the hand(s) as if the virtual object were physically pushed by the hand(s) of the user.

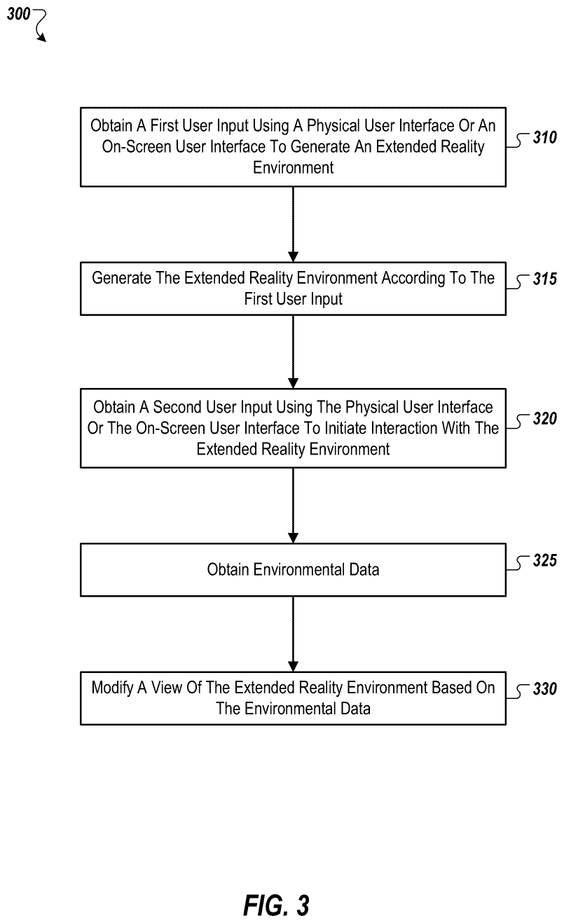

FIG. 3 illustrates a flowchart of an example method 300 to generate and interact with an XR environment, in accordance with at least one embodiment of the present disclosure. One or more operations of the method 300 may be performed by a system or device, or combinations thereof, such as the spatial computer 200 of FIG. 2 and/or the device 100 of FIGS. 1A-1E. Although illustrated as discrete blocks, various blocks of the method 300 may be divided into additional blocks, combined into fewer blocks, or eliminated, depending on the implementation.

At block 310, a first user input may be obtained using a physical user interface or an on-screen user interface to generate an XR environment. In some embodiments, the first user input may be effective to cause the processor of the device 100 of FIGS. 1A-1E and/or the processor 210 of the spatial computer 200 of FIG. 2 to generate the XR environment. In some embodiments, the XR environment may include an augmented space depicting a physical environment. In these and other embodiments, the physical environment may include any physical space that may be suitable for XR. In these and other embodiments, image data (e.g., three-dimensional (3D) information) representative of the physical environment may be obtained. For example, cameras (e.g., the camera 114 of FIGS. 1A-1E and/or the camera module 228 of FIG. 2) may be used to obtain the image data. The image data may include data representative of a shape, a location, a depth, and other features of the physical environment. Features of the physical environment may include a floor, a wall, a ceiling, etc. In some embodiments, the XR environment may include a virtual space unrelated to the physical environment.

In some embodiments, the first user input may relate to a launch of a specific application. For example, the specific application may involve different virtual objects (e.g., different augmented reality (AR) objects and/or virtual reality objects). For instance, the specific application may include gameplay involving movement of boxes. In these instances, the different virtual objects may include the boxes.

At block 315, the XR environment may be generated according to the first user input. In some embodiments, the virtual objects may be generated in the XR environment. In some embodiments, there may be different types of virtual objects shown in the XR environment. For example, the virtual objects may include everyday objects such as boxes, books, virtual characters, etc. In these and other embodiments, the request may include a request to include particular types of virtual objects in the XR environment. In some embodiments, the XR environment and the virtual objects may be shown on a display (e.g., the display 108 of FIGS. 1A-1E and/or the display 218 of FIG. 2). For example, the virtual objects may be shown as being in the XR environment. In some embodiments, the view of the XR environment may change as the orientation of the device changes. For instance, the cameras may move as the device moves and different parts of the XR environment may be shown in the view of the display. For example, the physical environment may include a room and as the device and the camera move (e.g., the camera points to different parts of the room), different parts of the room may be shown in the view of the display. In these and other embodiments, the virtual objects may be considered as a part of the XR environment and may stay where the virtual objects are placed unless moved otherwise via user input.

In some embodiments, the XR environment may be generated such that the XR environment remains in a certain orientation relative to the physical environment regardless of the orientation and/or movement of the device. For example, the view of the XR environment shown on the display may be auto-rotated and/or leveled such that the XR environment remains in a certain orientation relative to the physical environment even when an orientation of the device changes. For instance, the XR environment may remain level with the ground of the physical environment irrespective of physical orientation of the device.

At block 320, a second user input may be obtained using the physical user interface or the on-screen user interface to initiate interaction with the XR environment. For example, the second user input may specify to interact with a particular virtual object included in the XR environment. As another example, the second user input may specify to pick up a particular virtual object included in the XR environment. In some embodiments, the second user input may include a press of a button. In some embodiments, the button may remain pressed down by the user until the interaction with the particular virtual object is complete. For example, the user may press the button to pick up the particular virtual object and hold the button down until the user wishes to drop or disengage the particular virtual object by releasing the button. In some embodiments, the user may begin interacting with the particular virtual object with a press and release of the button and end the interaction with another press and release of the button. The second user input may interact with the XR environment as a whole (e.g., rotate the view of the XR environment out of the plane of the display).

At block 325, environmental data may be obtained. For example, the environmental data representative of movement (e.g., rotation, tilting, moving, etc.) of the device may be obtained using a tracking module such as the tracking module 222 of FIG. 2. In some embodiments, the environmental data may represent actions of the user after initiating interaction with the XR environment.

At block 330, a view of the XR environment may be modified based on the environmental data. For example, the user may initiate interaction with the particular virtual object via the second user input. As another example, the user may pick up the particular virtual object using the button. The user may move the device while engaging with the particular virtual object to move the particular virtual object within the XR environment. The view of the particular virtual object may be modified (e.g., shown on the display differently) to reflect such movement of the particular virtual object.

Modifications, additions, or omissions may be made to the method 300 without departing from the scope of the disclosure. For example, the operations of the method 300 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A device for extended reality comprising:
a sensor configured to generate image data representative of a physical environment of the device;
a tracking sensor configured to determine movement of the device within the physical environment;
a display configured to show a view of an extended reality environment;
a processor configured to control the view of the extended reality environment based on the image data, the determined movement of the device, and a position of the device in the physical environment; and
a control mechanism configured to obtain user input effective to interact with the extended reality environment.

2. The device of claim 1, wherein the processor is configured to generate, based on the image data, an extended reality environment as a virtual representation of the physical environment.

3. The device of claim 1, wherein the tracking sensor includes at least one of an accelerometer, a magnetometer, a gyroscope, or a magnetic compass.

4. The device of claim 1, wherein the tracking sensor includes a global positioning system.

5. The device of claim 1, further comprising an eye tracking device configured to track at least one of a location, an orientation, or movement of an eye of a user to orient the view of the extended reality environment shown on the display.

6. The device of claim 5 wherein:
the extended reality environment comprises a virtual character including an eye; and
the eye tracking device is configured to track at least one of the location, the orientation, or the movement of the eye of the user to adjust a direction of a gaze of the eye of the virtual character to maintain apparent eye contact with the user.

7. The device of claim 1 wherein:
the extended reality environment comprises a virtual character; and
the device further comprises a speaker configured to output audible sounds representative of speech of the virtual character.

8. The device of claim 1, wherein the sensor includes a camera.

9. The device of claim 1, further comprising a hand-tracking sensor configured to track movement of a hand of a user in the physical environment to permit interaction of the user with a virtual object in the extended reality environment.

10. The device of claim 1, wherein the processor is configured to maintain a particular orientation of the extended reality environment regardless of movement of the device.

11. The device of claim 1, wherein the display is touch sensitive and the display is configured to show an on-screen user interface that a user may interact with via touch.

12. The device of claim 1, wherein:
the display is configured to show an on-screen user interface that a user may interact with; and
a position of the on-screen user interface on the display is based on a handedness of a user.

13. The device of claim 1, wherein the control mechanism includes a button configured to indicate an interaction of a user with the extended reality environment.

14. The device of claim 1, wherein the control mechanism permits interaction of a user with the extended reality environment based on a rotational angle of the device.

15. The device of claim 1, further comprising a rechargeable battery.

16. The device of claim 1, wherein:
the extended reality environment comprises a virtual object; and
the processor is configured to modify a depiction of the virtual object within the extended reality environment based on the user input to permit manipulation of the virtual object within the extended reality environment.

17. A system comprising:
a display configured to show a view of an extended reality environment;
a processor configured to control the view of the extended reality environment;
a housing configured to house the processor and the display, the housing comprising a lower body configured to act as a handle for the system; and
a button attached to the lower body, the button configured to receive user input effective to initiate engagement with the extended reality environment.

18. The system of claim 17, wherein the processor is configured to generate a virtual object within the extended reality environment.

19. The system of claim 17, wherein the processor is configured to maintain a particular orientation of the extended reality environment regardless of movement of the system.

20. The system of claim 17 further comprising a tracking sensor configured to determine movement of the system.

21. The system of claim 17, wherein the processor is configured to control the view of the extended reality environment based on the determined movement of the system.

22. The system of claim 17 further comprising a camera configured to capture image data representative of a physical environment of the system, wherein the extended reality environment is generated based on the image data.

23. The system of claim 17, further comprising a hand-tracking sensor configured to track movement of a hand of a user in a physical environment of the system to permit interaction of the user with a virtual object in the extended reality environment.

24. A device for extended reality comprising:
a sensor configured to generate environmental data;
a processor configured to generate an extended reality environment based on the environmental data;
a display configured to show a view of the extended reality environment;
a housing configured to partially house the display, the housing being sized and shaped to be held in a hand of a user; and
a control mechanism positioned on a periphery of the housing, the control mechanism configured to obtain user input effective to interact with the extended reality environment, wherein the processor is configured to control the view of the extended reality environment shown on the display based on the user input.
